(19) United States
(12) Patent Application Publication
(10) Pub. No.: US 2004/0231663 A1
(43) Pub. Date: Nov. 25, 2004

(54) Process for the preparation of white and brown sugar from sugar beets

(76) Inventors: Melvin Paul Carter, Nakskov (DK); Ole Christen Hansen, Nakskov (DK); John Jensen, Nakskov (DK)

Correspondence Address: Sterne Kessler, Goldstein & Fox, Suite 600, 1100 New York Avenue NW, Washington, DC, 20005-3934, US

(21) Appl. No.: 10/487,557

(22) PCT Filed: Aug. 20, 2002
(86) PCT No.: PCT/DK02/00546

(30) Foreign Application Priority Data
Aug. 24, 2001 (DK) PA 2001 01259

(51) Int. Cl. C13F 1/02; C13F 3/00

(52) U.S. Cl. 127/61; 127/30

(57) ABSTRACT

A process for the preparation of white and brown sugar from raw diffuser beet juice. The juice is purified by membrane filtration at 70-95° C. on a filter having a molecular weight cut-off between 2,000 and 500,000 Dalton and evaporated to a dry matter content of between 60 and 80% by weight under vacuum to a thick juice. A conventional multi-step evaporative crystallisation of the thick juice gives crops of white and brown sugar crystals. The brown sugar obtained have valuable organoleptic properties.

### TECHNICAL FIELD

The present invention relates to a process for the preparation of sugar crystals, such as white and brown sugar, by purification of raw beet juice followed by evaporation and crystallisation.

### TECHNICAL BACKGROUND

Conventional sugar preparation from sugar beets comprises as the first step the preparation of raw beet juice by cleaning the beets, cutting to cosettes and extraction with water. The extraction can be carried out in a diffuser and accordingly the raw juice is often termed diffusion juice or diffuser juice.

The raw diffuser juice is then purified by one or more treatments each comprising a sequence of limiting, carbonation and filtration. By the liming calcium oxide or calcium hydroxide is added typically raising the pH to above about 12.6. Thereafter the calcium is precipitated by addition of carbon dioxide (carbonation) or another acid and then the precipitate is removed from the juice by conventional filtration. Typically the purification comprises two such precipitation treatments.

After the precipitation treatments the juice is subjected to sulfitation (addition of SO₂) to prevent colour formation.

The purified juice is then evaporated at a temperature starting at about 130° C. and gradually falling to about 80° C. under vacuum to a syrup having a dry matter content of about 70% by weight and the syrup is further evaporated under vacuum at 80° C. in a three step evaporative crystallisation starting in a first evaporative crystalliser wherein the syrup is further concentrated to about 91% by weight of dry matter and the white sugar crystals formed in the evaporative crystalliser are recovered by phase separation such as by centrifugation.

The mother liquid is subjected to two further steps of concentration in an evaporative crystalliser followed by centrifugation. The crystals obtained by the latter two steps of centrifugation contains impurities. To ensure a sufficient yield and final sugar quality they can be dissolved and recycled to the first evaporative crystalliser whereas the last mother liquid, molasses, can be used as animal feed and for fermentation.

The sugar crystals obtained from the second and third evaporative crystallisers by the conventional process appear as brown (raw) sugar. However, this brown sugar obtained from beets have an unpleasant off-taste and odour which is not acceptable to the consumer. Therefore it is necessary to redissolve the sugar crystals and recycle them to the first evaporative crystalliser although this increases the cost of operation and equipment.

The traditional precipitation treatments with lime and carbon dioxide are known to be disadvantageous both from an environmental and an energy consumption point of view. Thus several approaches have been made to find alternative purification methods. In some cases the number of precipitation treatments has been reduced and in other cases alternative chemicals are proposed.

U.S. Pat. No. 5,759,283 (Ekern et al.) discloses a method for processing sugar beets to produce a purified beet juice product. The juice is prelimed by the addition of lime and calcium carbonate whereafter the prelimed juice is subjected to filtration through a filtration membrane having a pore size of about 0.002 to 0.5 μm producing a retentate which does not pass through the filter membrane and a permeate passing through the membrane. The permeate is then treated with carbon dioxide gas to eliminate dissolved lime from the permeate and produce a purified beet juice product therefrom. The method limits the number of lime+carbonation treatments to one treatment instead of the traditional two treatments for producing white sugar from sugar beets but this treatment with chemicals is not completely avoided.

WO 98/21368 discloses a process for sugar beet juice clarification wherein the liming and carbonation is replaced with a step wherein raw diffusion juice is held above 70° C. at alkaline pH for sufficient duration to effect significant agglomeration. The agglomerated particles are removed by phase separation such as centrifugation or filtration. In one embodiment the separation involves a pre-screening and a membrane filtration. Although the liming and carbonation is avoided by this process it does still involve addition of chemicals and a conventional softening step is necessary.

U.S. Pat. No. 5,902,409 (Kwok et al.) clarifies sugar cane or sugar beet juice by cross flow MF, UF or NF. The process comprises a clarification step with addition of chemicals in the form of a flocculant such as slaked lime or a cationic surfactant

EP-A-1 046 718 (Eridania S.p.A. et al.) clarifies up to 50% of raw sugar beet juice by an alternative treatment based on a pre-filtration followed by a membrane filtration whereas the remaining portion of the juice is clarified by conventional addition of CaO, first carbonation, filtration, second carbonation and additional filtration. The alternatively treated permeate is mixed with the clear juice of the first carbonation. According to the examples the resulting purified juice does not show huge differences from juice purified by the traditional method with respect to purity, pH, colour and alkalinity. The specification discloses no teaching of the preparation of brown sugar from sugar beets.

EP-A-0 957 178 (Eridiania) separates organic and mineral particles whose size is above 50 μm from raw sugar beet juice followed by MF or UF using membranes of between a molecular weight cut-off (MWCO) of 5000 Dalton and 0.5 μm. The juice is then concentrated and a first crop of white sugar crystals is obtained by cooling crystallisation. According to the teaching of EP-A-0 957 178 the use of cooling crystallization instead of the conventional evaporative crystallisation is an essential feature making it possible to obtain white sugar of commercial quality from the above membrane filtered raw sugar beet juice. The mother liquid from the first crystallisation step is treated in two further cooling crystallisation steps giving a second and a third crop of sugar crystals. The purity of these two crops, especially the last one, is not sufficient for white sugar. These crops are therefore dissolved and recycled to the first concentration/crystallisation step. In some cases the second crop of sugar crystals can be used as a “particular” kind of sugar of commercial quality having a particular colour shade and a particular morphology. However, in case the second and third crops as an alternative are obtained by evaporative crystallisation re-working thereof is necessary.

Evaporative crystallisation gives a higher sugar crystal yield than cooling crystallisation. This means the high purity juices found in Northern Europe can be exhausted of sugar in a traditional three-stage crystallisation process, whereas cooling crystallisation will require a four-stage crystallisation process. This makes the evaporative crystallisation process simpler and more cost-efficient.

The methods of evaporative crystallisation and the subsequent centrifugation have been developed and optimised over decades and all over the sugar beet industry use can be made of the existing well functioning equipment for established process methods with the benefit of existing know-how and operator skills.

A commercial use of cooling crystallisation as taught according to EP-A-0 957 178 would require further development of the optimum equipment, process parameters and operating methods for a multi-stage cooling crystallisation process. Furthermore, the crystallisation rates would be slower at the lower temperatures, which typically start at about 80° C. and then go down to about 30° C., whereas evaporative crystallisation typically is carried out at a constant temperature about 80° C. This means that the cooling crystallisation times are longer, which gives a larger volume of product in process and accordingly requires a larger volume of equipment Also the kinetic mechanisms and the varying hydrodynamic conditions of cooling crystalisation are more complex, which make the control and optimisation more difficult.

According to the analytical data disclosed the second crop obtained according to EP-A-0 957 178 have a colour of 220 ICUMSA units (IU). This colour is more similar to that ofplantation white sugar from cane rather than brown sugar, which from cane typically has a colour from 800 to 8000 IU. It can be concluded that the disclosed second crop is not similar to a well tasting brown sugar product which could replace the known brown sugar products based on sugar cane.

U.S. Pat. No. 4,432,806 (Madsen et al.) purifies sugar beet juice by conventional filtration and UF. Before the UF the sugar juice is subjected to a chemical treatment with an oxidant, a complexing agent or a mixture thereof in order to convert low molecular non-sugars into higher molecular compounds and to convert non-soluble compounds into soluble compounds. This chemical treatment facilitates the UF-step. After the UF-step thejuice is subjected to conventional liming. How to prepare an acceptable brown-sugar product from sugar beets is not taught by Madsen et al.

U.S. Pat. No. 3,799,806 (Madsen) treats the raw juice mechanically followed by pH adjustment up to pH 11.5 with CaO in case of beet juice. The juice is subjected to UF and further purified by conventional means. Preparation of an acceptable brown sugar product from sugar beets is not taught.

WO 01/14594 (Tate & Lyle) discloses a process for the preparation of white sugar from sugar beets whereby the raw juice is not obtained by the conventional diffusion. Thus the juice is obtained by a mechanical separation from macerated beets. The obtained juice having a content of impurities differing from that of conventional raw diffuser beet juice is then purified by one or more membrane filtration steps. In a preferred embodiment the purification include a first UF using a preferred molecular weight cut-off between 4000 and 200,000 daltons followed by a second UF of the permeate prefer-ably using 1000 to 4000 daltons. Finally the second permeate is subjected to nanofiltration (NF) to remove a large percentage of the smallest impurities and the NF-retentate is evaporated and crystallised to obtain one ore two crops of white sugar. In several embodiments use is made of chemicals such as ozone, hydrogen peroxide, sodium hydroxide, sulfur dioxide, sulfate salts or sulfite salts. Preparation of an acceptable brown sugar product from sugar beets is not taught

EP-B-0 413 796 (Agrana Zucker-Gesellschaft) discloses a multistage process for the preparation of white sugar and a special crude sugar from sugar beets. In the first stage the beets are washed and comminuted and then blanched at 70 to 90° C. by direct heating with steam. The condensate obtained contains saponins and odoriferous substances which are undesired in sugar products and phenoloxidase is inactivated. This condensate is purified by conventional liming and carbonation and is used for the preparation of white sugar. The remaining beet cosettes are then further extracted or pressed to obtain a juice for the special crude sugar having a high content of valuable substances, for example vitamins, but not bitter and/or odoriferous substances and enzymes. However, such product will contain high molecular weight compounds such as proteins, pectins, colourants and insoluble solids which make the product unfit as a replacement of the commercial brown sugar having a taste and aroma originating from sugar canes. Furthermore, the process taught in EP-B-0 413 796 requires an extraction system which is different from the conventional extraction system, which are already available within the sugar beet industry.

Beside the commercial white sugar the lesser purified products such as light brown sugar and golden brown sugar are also of commercial interest due to the aromatic taste. However, these brown sugar products are traditionally prepared from sugar canes because the brown sugar obtained from sugar beets have an undesired off-taste which is not acceptable to the consumer.

In countries with sugar manufacture based on sugar beets the preparation of organoleptically acceptable brown sugar products is still based on imported cane sugar materials. Thus brown sugar can be prepared from a mixture of about 90% by weight of white sugar from sugar beets and about 10% by weight of cane molasses.

From an economic point of view it is unsatisfying that the raw sugar crystals obtained in the second and third evaporative crystalliser cannot be used as commercial products when the sugar originates from sugar beets. In fact it is very energy consuming to dissolve the crystals once more and then again evaporate the obtained juice or syrup.

Accordingly it would be desirable to establish a process for the purification of raw sugar beet juice in such a way that impurities contributing to the good taste and aroma of a raw brown sugar product will be present in the crystals obtained from the second and third evaporative crystallisers without maintenance of the unpleasant off-taste and odour.

Especially it would be desirable if all of the different crops of sugar crystals obtained by the evaporative crystallisation steps could be in the form of commercial products. In that case the energy consuming re-working of crystals with lesser purity by-dissolution and re-crystallisation could be reduced or omitted depending on the market demand of the brown sugar products.

Furthermore it would be desirable to avoid the traditional chemical treatment of the raw diffuser juice such as liming and carbonation.

Finally it would be desirable to use the produced molasses to replace imported cane molasses in the manufacture of brown sugars.

### BRIEF DESCRIPTIONS OF THE INVENTION

The object of the present invention is to provide an alternative purification process without traditional liming and carbonation whereby impurities which are undesired in brown sugar products are removed whereas impurities providing a good taste and aroma will remain in the crops of crystals having a lesser purity obtained by evapora-tive crystallisation.

Accordingly the present invention relates to a process for the preparation of sugar crystals from raw diffuser beet juice by purification followed by evaporative crystallisation, whereby the raw juice is subjected to the steps of

a) heating to 70-95° C.,

b) optionally, pre-filtration,

c) membrane filtration on a filter having a molecular weight cut-off between 2,000 and 500,000 Dalton,

d) evaporation to a dry matter content of between 60 and 80% by weight under vacuum,

e) crystallisation by further evaporation followed by phase separation resulting in a crop of sugar crystals, such as white sugar crystals, and a liquid phase, and

f) one or more further steps wherein the liquid phase from the preceding step is subjected to crystallisation by evaporation and phase separation resulting in further crops in the form of sugar crystals, such as light brown and golden brown sugar crystals, and molasses as the liquid phase from the last step.

By the inventive process it has been possible

to produce commercially valuable (saleable) crystalline sugar products free of chemical additions,

to eliminate lime-containing waste products which are undesired for environmental reasons,

to reduce the number of operating steps,

to prepare desirable brown sugar products from sugar beets without importation of raw materials from sugar cane growing countries,

to reduce or completely eliminate recycling of crystallised sugar with lesser purity by dissolving and recrystallisation,

to produce molasses with a better taste and aroma than conventional beet molasses, and

to produce molasses for blending with white sugar to make brown sugar, thereby avoiding the need to use imported cane molasses.

An advantage of the inventive process is that it easily can be incorporated into an existing sugar beet factory because both the preparation of the raw diffuser beet juice and the evaporation and crystallisation steps (steps d to f) are carried out on equipment already being present on the existing factories.

The extent of applicability of the invention appears from the following detailed description. It should, however, be understood that the detailed description and the specific examples are merely included to illustrate the preferred embodiments, and that various alterations and modifications within the scope of protection will be obvious to persons skilled in the art on the basis of the detailed description.

### BRIEF DESCRIPTION OF THE DRAWING

FIG. 1 is a schematic flow sheet of the inventive process according to a preferred embodiment using UF in step (c) and evaporative crystallisation in three steps.

FIG. 2 is a schematic flow sheet of a particular embodiment of the inventive process leading to a white sugar of high purity in a process free of chemicals.

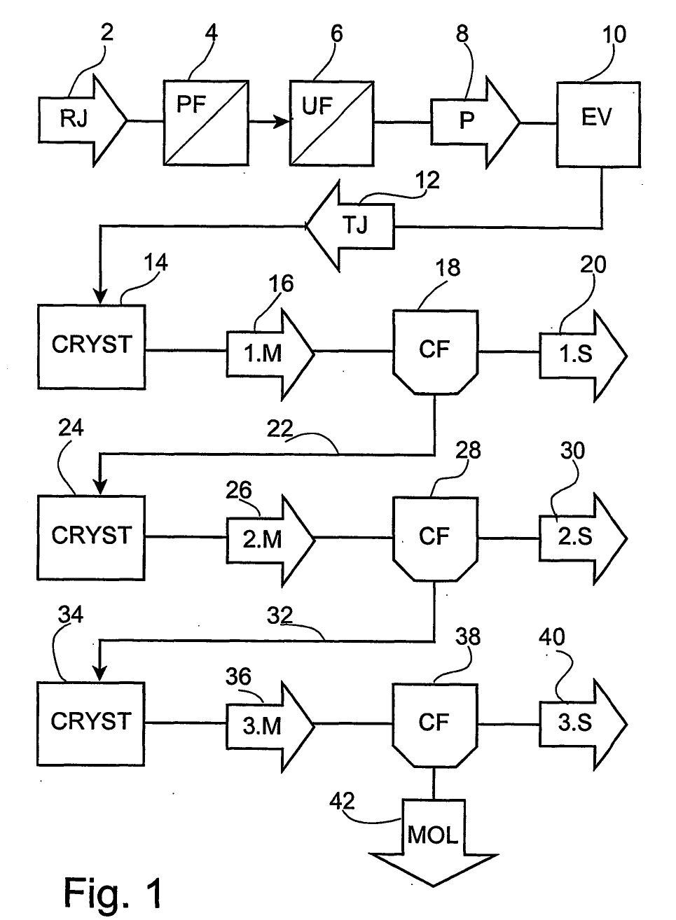

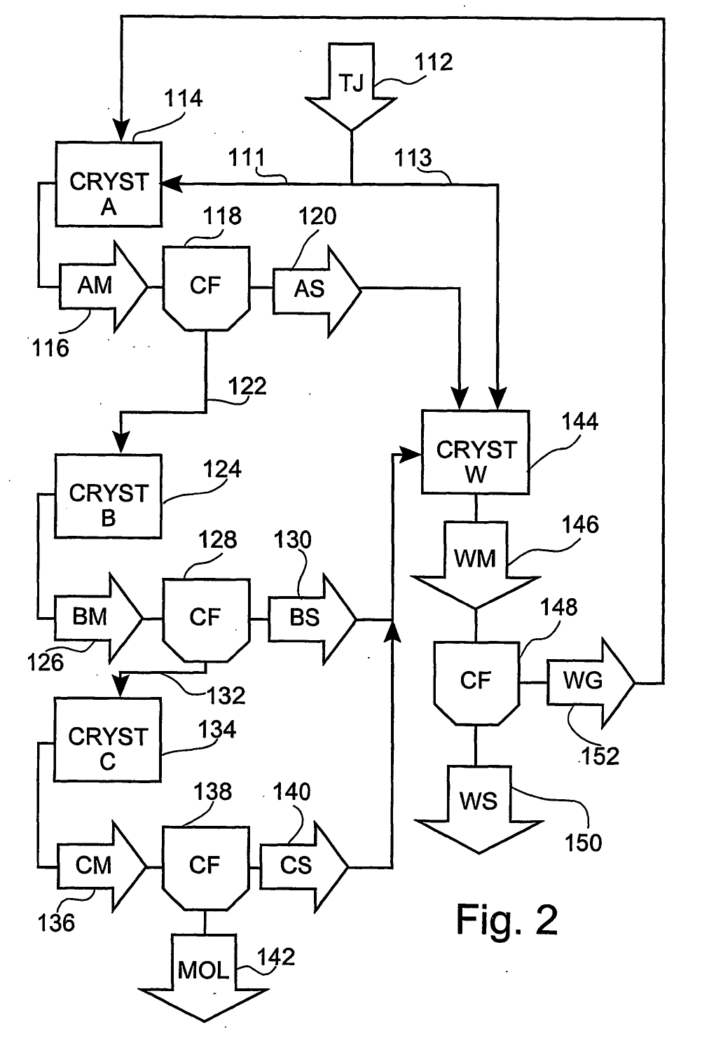

Following abbreviations are used in FIGS. 1 and 2:

RJ Raw Juice

PP Pre-filtration

UF Ultrafiltration

P Permeate

EV Evaporation

T1 Thick Juice

CRYST Crystallisation (evaporative)

1.M, 2.M and 3.M First, Second and Third Massecuite

CF Centrifugation

1.S, 2.S and 3.S First, Second and Third Sugar Crop

MOL Molasses

CRYST A, B, C and W Crystallisation A, B, C and W

AM, BM, CM and WM Massecuite A, B, C and W

AS. BS, CS and WS Sugar A, B, C and W

WG W Green*

* Green syrup, the first syrup, or run-off, produced on centrifuging a massecuite or magma.

### DETAILED DESCRIPTION OF THE INVENTION

The process according to the present invention comprises an alternative juice purification including the steps of heating to 70-95° C. (step a), an optional step of prefiltration (step b) and a step of membrane filtration (step c) followed by a per se conventional multi-step, especially three steps, evaporative crystallisation (steps d to f) only differing from the usual process by the fact that all crops of sugar crystals need not to be re-worked by dissolution and recrystallisation because they are all per se commercially valuable and hence saleable products due to their attractive taste and aroma.

The purified juice obtained as the permeate from the membrane filtration step c has a pattern of non sugar compounds remaining in the juice which is different from the pattern found in the juice obtained by the conventional juice purification method of liming and carbonation.

By the conventional method approximately 35% by weight of non sugar compounds are removed from the raw beet sugar juice calculated on dry matter basis. These non sugar compounds include both high and low molecular weight compounds including water insoluble compounds such as cellulose, pectic substances, proteins, saponins, lipids and ash, and soluble substances, such as monosaccharides, raffinose, pectic substances, organic acids, lipids, saponins, proteins, betaine, colorants, amino acids, amides, ammonium salts, nitrates, nitrites, and inorganic compounds (ash) such as potassium, sodium, calcium, magnesium, chlorides, sulphates, phosphates, iron, aluminium and silicates.

In spite of this substantial removal of non sugar impurities by the conventional method the purified juice still contain some remaining impurities which by three step crystallisation are found in a higher concentration in the second and third crops of sugar crystals after removal of the pure (white) crystals obtained as the first crop. Unfortunately these remaining impurities are found in a pattern making the brown sugar crops organoleptically unacceptable.

The removal of non sugar impurities by cross-flow membrane filtration of the raw diffusion juice according to the present invention leaves another pattern of remained impurities. Thus some impurities, which were removed by the conventional purification process, will remain in the juice. Especially low molecular weight compounds, such as organic acids, amino acids and colorants, will not be removed from the juice and will contribute to attractive characteristics of the brown sugars and molasses obtained from the juice.

Furthermore, the less desirable flavour of conventional beet syrups is inter alia associated with certain pyrazines and dimethyl disulfide which compounds are absent in cane molasses. Pyrazines are a class of nitrogen-containing heterocyclic compounds formed by the reaction of glucose with amino acids via the Maillard reaction. Certain pyrazines are important flavour ingredients in heated foods such as bread, baked potatoes and coffee. However, pyrazines formed from sulfur amino acids, such as cysteine and methionine, provide a less desirable sulfurous odour such as that of dimethyl disulfide, which is a reaction product of methionine. These reactions are promoted by raising the pH of the juice, because this increases the proportion of amino acids in the unprotonated form, which again increases the rate of the initial condensation step in the Maillard reaction.

For the above reasons a more desirable flavour in the final sugar products is promoted by avoiding the conventional liming and by operating the inventive process at the natural acidic pH—that is without addition of pH adjusting chemicals.

Accordingly the inventive process is preferably carried out at a pH not higher than 7, more preferred at pH 5.6 to 6.8, such as pH 5.8 to 6.5. Such pH values are those naturally occurring in the juice when no pH adjusting compounds are added.

Juice Purification

Step a. Heating

To maintain the microbiological stability of raw diffuser juice and to improve the filtration rates the juice purification is carried out at elevated temperature. Thus, at the first step the raw diffusion beet juice obtained in any conventional manner is heated to between 70 and 95° C., preferably between 75 and 90° C., such as about 80° C. before the filtration step(s).

Step (b). Pre-Filtration

Prior to the membrane filtration (step c) the purified juice is preferably pre-filtered. The objective of the pre-filtration is to protect the membrane filter used in the following step (c) from erosion, plugging and blocking by removing particles such as sand and fibres. Such particle filtration before membrane filtration is usually recommended by the suppliers of membrane filters and the actual choice of the filter for the pre-filtration depend on the membrane filter used. Thus Koch Membrane Systems, Inc., Wilmington, Mass., USA, recommend pre-filtration to only 100 μm before their spiral membranes, because they have an increased spacer size which makes them less prone to blocking. S.C.T., Bazet, France, recommend a pre-filter with a 60 μm absolute rating to protect their ceramic membranes.

It is possible to use tighter pre-filters down to 5 μm or at least down to 15 μm whereby not only coarse sand but also fine sand is removed. The use of such fine filters for the pre-filtration has no effect on the final product characteristics but it can affect the life time of the membranes.

At present it is believed to be sufficient to remove particles larger than 50 μm in order to facilitate the following membrane filtration and protect the membrane filters. Hereby remaining pulp and suspended particles such as sand which can foul the membranes will be removed by the pre-filtration.

Preferably the filter used to the pre-filtration has a pore size between 30 and 150 μm, more preferred between 45 and 100 μm, such as between 50 and 70 μm.

Static curved wedge wire screens are available down to 50 μm and are one option for the pre-filtration. Back-flushable filters are another option. An example is the Phoenix filter (available from Cross Manufacturing Co. (1938) Ltd., Bath, England), which is a coil filter with rating of 50 μm. The specially designed “turbo” flow path keeps particulate material away from the filter elements, reducing backwashing frequency. The coil opens on backwashing allowing complete and thorough cleaning. Société des Ceramiques Thechniques (S.C.T), Bazet, France, offer a self-cleaning pre-filter with a 60 μm absolute rating recommended for use prior to their membrane filtration system “Membralox” comprising ceramic membranes in the MF and UF range. The Phoenix filter can also be obtained with pore sizes of 12 μm, 25 μm, 75 μm and higher.

Membrane Filtration

The objective of the membrane filtration step (c) is to remove all suspended solids and macromolecules. This can be done by microfiltration (MF) or ultrafiltration (UF).

The distinction between the membrane classes MF (microfiltration) and UF (ultrafiltration) varies with different authors and the ranges are overlapping. The firm Osmonics, Inc, Minnetonka, Minn., USA defines MF to be separating in the 0.02 to 2.0 μm range and UF in the 0.002 to 0.2 μm range corresponding to the 500 to 300,000 molecular weight cut-off range.

Generally MF is used to retain particles ranging in diameter from 0.1 to 10 μm. MF filters are typically manufactured of polymers, or ceramics, and most are characterised as being isotropic, which means the membrane pores are the same size throughout the depth of the filter. They are used to remove mainly insoluble compounds rather than the soluble high molecular weight substances. For this one reason UF membranes are preferred for the present invention. Another reason is that bacterial substances are removed, while high capacity and stability performance can be maintained. Depending on the molecular weight cut-off value UF membranes remove both particles and macromolecules with a molecular weight of 2,000 to 500,000 Da (dalton). These membranes are usually asymmetric or anisotropic, which means the membrane consists of an extremely thin layer of homogeneous polymer, which is supported on a thick spongy substrate. The pores of the thin layer or “skin” are much smaller than the pores of the rest of the membrane. The skin therefore constitutes the major, transport barrier and governs the filtration characteristics of the UF membrane.

The membrane filters usable for the present invention range from UF filters with a molecular weight cut-off value of 2,000 Da or more up to MF filters retaining particles of about 0.3 μm. According to Osmonics, Inc. this corresponds to a molecular weight cut-off of about 500,000 Da. To ensure the attractive pattern of the remaining impurities the preferred lower limit for the cut-off value is about 5,000 Da, more preferred 7,000 Da and most preferred 10,000 Da. The upper limit is about 500,000 Da, preferably 150,000 Da and more preferred 70,000 Da.

For the present invention the preferred membrane filters belong to the UF range to ensure that also some relevant macromolecules are removed, including such macromolecules as proteins and pectin and colloidal substances which are greater than 0.05 to 0.1 μm as well as colorants.

There are several types of useful membrane equipment on the market. These include tubes, spirals and plates. Spiral wound membranes are relatively inexpensive and very compact. However, due to the design with a netlike feed spacer they can only be used when the pre-filtration has been carried out with a sufficiently fine filter in the range from 100 μm or tighter depending on the size of the mesh spacer.

The membrane filtration is preferably carried out as a cross-flow (or tangential flow) of the liquid feed over the membrane. This allows continuous cleaning of the membrane surface and high filtration rates. Intermittent cleaning of the membranes is required with caustics, acids, detergents or a combination to maintain high flow rates of the permeate.

MF and UF membranes have previously been proposed to clarify raw juice to remove turbidity and colloidal particles followed by some other highly effective purification steps, such as colour removal by addition of chemicals, juice softening (i.e. removal of Ca and Mg ions) and chromatography using ion exchange resins. However, such purification sequences were proposed or used with the focus on producing white sugar, which means that maintenance of aromatic and well tasting impurities characteristic for brown sugar products was not considered.

On the membrane filtration field polymeric, stainless steel, ceramic and carbon membranes suitable for sugar applications have been developed in recent years. Examples of companies supplying such membrane filtration systems are Koch Membrane Systems, Inc., Wilmington, Mass., USA, Graver Technologies, Glasgow, Del., USA, S.C.T., Bazet, France, Osmonics, Inc, Minnetonka, Minn., USA, Danish Separation Systems, Nakskov, Denmark, and Applexion, Epone, France.

Spiral wound membranes are energy efficient, compact and economical to install and are good for concentration and clarification applications. They are made of a variety of polymeric materials including polypropylene, polysulfone and polyvinylidene fluoride.

Tubular membranes are wide diameter membranes and comprise polymeric or inert materials, including carbon, ceramics and porous metals such as stainless steel. They are best used for concentration and clarification of streams where spirals are less suitable, such as streams with high levels of suspended solids or where there is limited pre-filtration.

Electrodialysis

According to a preferred embodiment the membrane filtrated juice obtained as permeate can be further purified by an optional demineralisation step by per se known electrodialyses (ED). The ED membranes are temperature sensitive and therefore the temperature of the juice must be reduced to 60° C. or below for example using heat exchangers.

The juice obtained after the membrane filtration has normally a dry matter of about 15% by weight (°Brix) and can be subjected to ED as such. However, a sugar juice of 30% by weight of dry matter has maximum electrical conductivity giving the most effective demineralisation by ED. Accordingly the membrane filtration permeate is preferably subjected to a preliminary evaporation to a dry matter content of 25 to 35% by weight before the ED demineralisation step. After the demineralisation the juice is then further evaporated to a dry matter content of 60 to 80% by weight and further subjected to evaporative crystallisation as described below.

ED units usable for treating membrane filtrated raw sugar juice are commercially available, for example from Eurodia Industrie S.A., Wissous, France.

By electrodialysis the inorganic and organic salts remaining in the membrane filtration permeate are separated using alternative cation and anion exchange membranes. A direct current is passed through the membrane stack causing anions to move through the anion exchange membrane and the cations through the cation exchange membrane.

By the ED some low molecular weight colorants are removed. Furthermore the brown sugars obtained after evaporation and crystallisation have a higher purity and a lower content of ash.

ED is effective at removing organic acids as well as inorganic salts. The removal of especially acetic acid avoids a too sharp aroma of the brown sugars.

The removal of salts by ED reduces the juice pH, typically to 5.2-5.4. This causes sucrose inversion during the subsequent processing. If desired, the pH can be raised using either a weak or strong basic ion exchange resin as a polish on a part of or the complete stream. This can be prefered for white sugar production, where loss by inversion is undesired. However, for brown sugar production the higher invert content gives sugars with a nice consistency and more humectant properties, which enables the moisture content and consistency to be better preserved.

Accordingly even more acceptable brown sugar products can be produced from membrane filtered raw juice when using an electrodialysis step between the membrane filtration and the final evaporation. The final products have less ash and or ganic acids, which increases their purity without much affecting the visual brown apperance. The removal of organic acids, especially acetic acid, prevents it dominating other desirable aromas from aldehydes and liquorice related compounds giving a more acceptable brown sugar product.

Evaporation and Crystallisation

After membrane filtration the purified juice is concentrated by evaporation in the normal way in a multiple-effect evaporator system typically found in sugar factories. The thick juice produced is then crystallised in the normal manner using the evaporation crystallisers typically found in all sugar factories.

Usable evaporative crystallisers can be batch evaporative crystallisers or continuous evaporative crystallisers, which are well known within the sugar industry. Reference can be made to P. W. van der Poel, H. Schiweck and T. Schwartz: “Sugar Technology—Beet and Cane Sugar Manufacture”, Bartens, 1998, pages 780-797.

The three-stage crystallisation of the sugar is done in the conventional way using the special batch or continuous evaporative crystallisation equipment developed over many years by the sugar industry.

In evaporative crystallisation the supersaturation necessary to induce crystal growth is achieved by evaporation of water. The crystal growth is either initiated by nucleation or injection of seed slurry or magma.

In principle evaporative crystallisation differ from the cooling crystallisation disclosed in EP-A-0 957 178 by the fact that the water is evaporated by use of a sufficiently high temperature generally combined with a reduced pressure. Thus in practice the temperature for evaporative crystallisation is generally above 70° C., preferably above 75° C. such as about 80° C., whereas the temperature by cooling crystallisation typically goes down to 30° C. This is necessary because unlike evaporative crystallisation no water is removed to maintain supersaturation, so the driving force for crystallisation has instead to be maintained by cooling.

The crystal growth is carried out at reduced pressure for energy efficiency and to limit colour formation. The crystals are separated from the concentrated juice by centrifugation in the normal way. However, by the present invention it is possible to omit significant washing of the crystals with water and re-dissolution and recycle of the crystals of sugar with lesser purity because they are now suitable as saleable products due to the interesting organoleptic qualities.

In this way substantial energy savings are ensured and the equipment capacity is increased.

The brown sugars obtained as the second and third crops in the three-stage crystallisation have an attractive quality and hence they possibly will have a high potential on the market. In case the demand of brown sugar fluctuates it will be possible to dissolve and recycle the brown sugar crops or a portion thereof in the conventional way. In that case the inventive process is still attractive because white sugar can be prepared from raw diffuser juice without use of any chemicals. Such sugar will be more acceptable to an increasing part of the consumers and the process will be an environmental improvement.

Also the molasses produced has a better taste and aroma as compared with conventional sugar beet molasses. Accordingly the molasses can be blended with the white sugar to produce a special soft brown product, enabling full product recovery and no waste.

Based on the quality of the molasses further use thereof can be contemplated as an ingredient in foods and beverages including foods and beverages which are further processed by a fermentation or by another conventional process.

### EXAMPLE 1

This example illustrates with reference to FIG. 1 a preferred embodiment of the inventive process.

Purification of Raw Diffuser Juice.

Raw diffuser juice (RJ) 2 prepared in conventional manner from sugar beets is prefiltered in a pre-filter (PF) 4 to remove particles such as sand and fibers and others that could damage the following membrane filter. The pre-filtered juice is then membrane filtered, in the present embodiment by ultrafiltration (UF) 6, whereby suspended solids and macromolecules are removed with the retentate. The purified juice obtained as the permeate (P) 8 from the ultrafiltration is then subjected to conventional 3 step evaporative crystallisation.

3 Step Crystallisation

The permeate 8 obtained above is first evaporated under vacuum in an evaporator (EV) 10 to a thick juice (TJ) 12. The thick juice is then subjected to evaporative crystallisation in a first evaporating crystalliser (CRYST) 14 the vacuum being maintained. The first massecuite (1.M) 16 is then separated in a first centrifuge (CF) 18 still under vacuum. The term massecuite is used within the sugar manufacture field for a mixture of sugar crystals and syrup as obtained in an evaporating or cooling crystalliser. In the first centrifuge 18 the massecuite is separated into a first crop of sugar crystals (1.S) 20 and a mother liquid or syrup 22. The syrup 22, still being under vacuum, is then treated in a second evaporating crystalliser 24 and in the same way as already described the obtained second massecuite (2.M) 26 is separated in a second centrifuge 28 into a second crop of sugar crystals (2.S) 30 and a syrup 32. Thereafter, in the same manner, the syrup 32, still being under vacuum, is treated in a third evaporating crystalliser 34 to obtain a third massecuite (3.M) 36, which is separated in a third centrifuge 38 into a third crop of sugar crystals (3.S) 40 and the mother liquid in the form of molasses (MOL) 42.

The three crops of sugar crystals 20, 30 and 40 are all commercially useful products as white sugar, light brown sugar and golden brown sugar, respectively. Thus—contrary to the conventional method—it is not necessary to dissolve the second and third crops of sugar crystals 30 and 40 and recycle the dissolved sugar to the first evaporating crystalliser 14.

### EXAMPLE 2

A raw diffusion juice obtained in conventional manner from sugar beets was heated to 80° C. and pre-filtered on a 50 μm vibrating screen pre-filter from Sweco, Stockholm, Sweden. The obtained filtrate was then filtered on a nominal 30 kDa UF membrane filter.

The purification efficiency is illustrated by the analyses shown in Table 1.

TABLE 1
Analysis of juice before and after a 30 kDa UF membrane

| Analysis | Raw juice | Permeate | % change |
|---|---|---|---|
| Colour (IU*) | 5980 | 2780 | −54 |
| pH | 6.2 | 6.2 | |
| Purity | 93.3 | 94.3 | +1 |

*ICUMSA units.

It appears that the UF increased the juice purity by 1% and reduced the colour by 54%.

### EXAMPLE 3

Using the method as described in example 1 a raw diffusion juice obtained in conventional manner from sugar beets was heated to 80° C. and pre-filtered on a 50 μm vibrating screen pre-filter from Sweco, Stockholm, Sweden. The obtained filtrate was then filtered on a nominal 30 kDa UF membrane filter.

The UF-purified juice was evaporated at 130 to 80° C. to a thick juice or syrup having a dry matter content of about 70% by weight. The syrup was subjected to evaporative crystallisation at 80° C. under vacuum in three stages with intermittent separation of the obtained crystals by centrifugation, the temperature at 80° C. being maintained. This gave a first crop of white sugar crystals having a colour of 86 IU (ICUMSA units), a second crop of light brown sugar having a colour of about 2500 IU and a third crop of golden brown sugar having a colour of about 11000 IU.

The amounts of the product streams and analytical data appears from table 2 below:

TABLE 2
(Example 3)

| | | | | | | |
|---|---|---|---|---|---|---|
| | | Pol* | °Brix** | | | |
| | | (% by | (% by | | | kg |
| | | weight | weight | Purity | | per |
| | ref. on | of pure | of dry | (% by | Colour | 100 kg |
| Material | | sucrose) | matter) | weight) | (IU***) | beets |

Process streams

| | | | | | | |
|---|---|---|---|---|---|---|
| Raw juice | RJ (2) | 14.1 | 15.4 | 91.5 | 5978 | 109 |
| Permeate | P (8) | 13.4 | 14.5 | 92.5 | 2690 | 115 |
| Thick juice | TJ (12) | 63.0 | 68.2 | 92.5 | 5111 | 28 |
| 1. | 1.M (16) | 84.1 | 91.0 | 92.5 | 6806 | 21 |
| Massecuite | | | | | | |
| 2. | 2.M (26) | 79.1 | 92.0 | 86.0 | 14056 | 10 |
| Massecuite | | | | | | |
| 3. | 3.M (36) | 66.1 | 93.0 | 71.1 | 35970 | 4 |
| Massecuite | | | | | | |

Final products

| | | | | | | |
|---|---|---|---|---|---|---|
| 1. Sugar | 1.S (20) | 99.9 | 100.0 | 99.9 | 86 | 10 |
| 2. Sugar | 2.S (30) | 98.3 | 99.8 | 98.5 | 2500 | 5 |
| 3. Sugar | 3.S (40) | 92.5 | 98.7 | 93.7 | 11000 | 1 |
| Molasses | MOL | 45.5 | 82.7 | 55.0 | 65500 | 4 |
| | (42) | | | | | |

*Pol: Polarization measured according to ICUMSA standard.
**°Brix: Standard measure based on the specific gravity.
***ICUMSA units.

The light brown sugar and the golden brown sugar obtained as the second and third crops, respectively, are compared in table 3 with the current brown sugar product “brun farin” made by blending white sugar with about 10% by weight of cane molasses.

TABLE 3

| | | Golden brown | Light brown |
|---|---|---|---|
| | “Brun | sugar | sugar |
| | farin” | (3. sugar) | (2. sugar) |
| Sucrose (% by | | 92.5 | 98.3 |
| weight) | | | |
| Invert sugar (% b. | | 0.8 | 0.2 |
| wt.) | | | |
| Ash (% by weight) | | 2.6 | 0.5 |
| Water (% by weight) | 1.8 | 1.3 | 0.2 |
| Colour (IU) | 12000 | 11000 | 2500 |

Although the measured colour of the “brun farin” is similar to that of the golden brown sugar obtained as the third sugar crop they in fact look visually quite different. Thus the new product has a more pleasing golden brown colour compared to the light chocolate brown colour of “brun farin”. Moreover, the two new brown sugar products have a favourable taste and aroma making them attractive to the consumers.

The obtained light and golden brown sugars are organoleptically judged to synergistically combine the natural acid-sour taste of the non-sugars found in the natural beet molasses with the sweetness of sucrose to give a pleasing flavour profile more similar to a cane based product than a conventional beet based product. This makes these brown sugar products novel because they are based on syrup of beet origin, instead of cane origin from which brown sugars are traditionally based.

The conventional juice purification process typically consumes between 2.2 and 3.5 tons of limestone per 100 tons of beets and 0.14 to 0.22 tons of coke. These expenses are saved by the inventive process. Furthermore the problems associated with disposing of the used lime sludge from the carbonation process are avoided by the inventive process.

Moreover, as the recycle of the second and third sugar crops is avoided by the present invention, the amount of massecuite to be processed in the sugarhouse is reduced from about 62 kg per 100 kg beets to about 35 kg per 100 kg beets. This increases the plant capacity and the water evaporation in the sugarhouse is reduced from about 11 kg per 100 kg beets to about 7.5 kg per 100 kg beets leading to energy savings.

### EXAMPLE 4

A golden brown sugar is prepared by mixing 90% by weight of the first crop of white sugar and 10% by weight of the molasses from example 3. The characteristics of the obtained product is shown in table 4 below.

### EXAMPLE 5

A golden brown sugar is prepared by mixing 95% by weight of the second crop of light brown sugar and 5% by weight of the molasses from example 3. The characteristics of the obtained product is shown in table 4 below.

TABLE 4

| | Example 4 | Example 5 |
|---|---|---|
| | 90% white sugar/10% | 95% light brown sugar/ |
| | molasses | 5% molasses |
| Sucrose (% by weight) | 94.6 | 97.3 |
| Invert sugar (% b. | 1.2 | 0.6 |
| wt.) | | |
| Ash (% by weight) | 1.3 | 0.7 |
| Water (% by weight) | 2.0 | 1.0 |
| Colour (IU) | 6570 | 3300 |

### EXAMPLE 6

This example illustrates with reference to FIG. 2 a special embodiment of the invention usable for the preparation of white sugar with increased purity without use of chemical treatment.

A thick juice 112 is prepared from raw diffuser juice by pre-filtration, ultrafiltration and evaporation as described in example 1. The thick juice is divided in two portions 111 and 113. One of these portions, portion 113, is combined with other materials which will be further described bellow in a fourth evaporation crystalliser (CRYST W) 144. The other portion, portion 111, is combined with a recycled mother liquid of green syrup (WG) 152 and the obtained mixture is subjected to a 3 step evaporation. The 3 step evaporation is carried out similar to that in example 1 whereby the steps A, B and C of this example correspond to steps 1, 2 and 3, respectively, of example 1.

Accordingly in the 3 step crystallisation the mixture of portion 111 and mother liquid 152 is first subjected to evaporative crystallisation in a first evaporating crystalliser (CRYST A) 114 the vacuum being maintained. The first massecuite (AM) 116 is then separated in a first centrifuge (CF) 118 still under vacuum. In the first centrifuge 118 the massecuite is separated into a first crop of sugar crystals (AS) 120 and a mother liquid or syrup 122. The syrup 122, still being under vacuum, is then treated in a second evaporating crystalliser (CRYST B) 124 and in the same way as already described the obtained second massecuite (BM) 126 is separated in a second centrifuge 128 into a second crop of sugar crystals (BS) 130 and a syrup 132. Thereafter, in the same manner, the syrup 132, still being under vacuum, is treated in a third evaporating crystalliser (CRYST C) 134 to obtain a third massecuite (CM) 136, which is separated in a third centrifuge 138 into a third crop of sugar crystals (CS) 140 and the mother liquid in the form of molasses (MOL) 142.

The first, second and third crops of sugar crystals 120, 130 and 140 are dissolved and combined with the portion 113 of thick juice and the obtained mixture is subjected to a fourth crystallisation in a fourth evaporating crystalliser (CRYST W) 144 to obtain a fourth massecuite (WM) 146, which is separated in a fourth centrifuge 148 into a crop of pure white sugar crystals (WS) 150 and the above mentioned mother liquid of green syrup (WG) 152 which as already mentioned is recycled and mixed with the portion 111 of thick juice.

An exemplification of the amounts of the product streams and analytical data using the embodiment according to Example 6 appears from table 5 below:

TABLE 5
(Example 6)

| | | | | |
|---|---|---|---|---|
| | | Purity | | kg per |
| | ref. on | (% by | Colour | 100 kg |
| Material | | weight) | (IU***) | beets |

Process streams

| | | | | |
|---|---|---|---|---|
| Raw juice | — | 92.50 | 4868 | 120 |
| Thick juice | TJ (112) | 92.46 | 5111 | 26.15 |
| 1. Massecuite (A) | AM (116) | 94.51 | 4139 | 27.47 |
| 2. Massecuite (B) | BM (126) | 89.61 | 9357 | 14.52 |
| 3. Massecuite (C) | CM (136) | 81.21 | 23534 | 8.53 |
| 1. Sugar (A) | AS (120) | 99.97 | 58 | 11.89 |
| 2. Sugar (B) | BS (130) | 99.95 | 184 | 5.94 |
| 3. Sugar (C) | CS (140) | 99.24 | 622 | 4.08 |
| 4. Massecuite (W) | WM (146) | 97.87 | 1802 | 32.59 |
| Mother liquid | WG (152) | 95.84 | 3506 | 18.35 |
| (W green) | | | | |

Final products

| | | | | |
|---|---|---|---|---|
| 4. Sugar (W) | WS (150) | 99.99 | 25 | 14.60 |
| Molasses | MOL (142) | 58.44 | 52423 | 4.04 |

***ICUMSA units.

It appears that a very pure white sugar (25 IU) is obtainable without use of chemicals for the purification. Depending on the demand for brown sugar this embodiment can be modified bearing in mind that the second and third crops of sugar (B and C) as vell as the molasses all possess interesting organoleptic qualities making them useful as saleable products per se or as ingredients in such products.

Advantages of the embodiment according to Example 6 are that the process is flexible allowing the desired sugar colour to be obtained by controlling the blend ratio of thick juice in the respective materials to be crystallised. This allows high quality sugar to be produced in a chemical-free process.

### EXAMPLE 7

A UF-purified juice was prepared as described in example 3 and evaporated to a dry matter content of about 30% by weight at 80° C. Then the juice was cooled to below 60° C. and then treated in an electrodialysis plant from Eurodia Industrie S.A., Wissous, France having a feed and bleed unit operating with four EUR640 P15 membrane stacks each with 25 cells and a current of 4 mA/cm².

The juice was analysed before and after the electrodialysis. The results are shown in table 6.

TABLE 6
Analysis of juice before and after electrodialysis

| | | Electrodialysed | |
|---|---|---|---|
| Analysis | UF-filteres juice | juice | % change |
| Colour (IU*) | 2350 | 2000 | −15 |
| pH | 6.2 | 5.3 | |
| Purity | 93.5 | 94.5 | +1 |

*ICUMSA units.

The electrodialysed juice was then evaporated at 80° C. to a thick juice or syrup having a dry matter content of about 70% by weight. The syrup was subjected to evaporative crystallisation at 80° C. under vacuum in three stages with intermittent separation of the obtained crystals by centrifugation, the temperature at 80° C. being maintained. This gave a first crop of white sugar crystals having a colour of 65 IU (ICUMSA units), a second crop of light brown sugar having a colour of about 1130 IU and a third crop of golden brown sugar having a colour of about 9850 IU.

Analysis of these light and golden brown sugars based on UF-treated and electrodialysed juice is shown in table 7.

TABLE 7
Analysis of 2. sugar and 3. sugar obtained from ultrafiltrated and
electrodialysed juice.

| | Light brown sugar | Golden brown sugar |
|---|---|---|
| | (2. sugar) | (3. sugar) |
| Sucrose (% by weight) | 99.5 | 93.0 |
| Invert sugar (% b. | 0.4 | 2.1 |
| wt.) | | |
| Ash (% by weight) | 0.6 | 0.5 |
| Water (% by weight) | 0.4 | 1.4 |
| Colour (IU) | 1130 | 9850 |

Comparing with the results in table 3 it appears that low molecular weight colorants not removed by the UF were removed by the electrodialysis whereby the colour was reduced for 1., 2. and 3. sugars. Furthermore the ash has been reduced and the purity increased for the brown sugars.

The sugars obtained according to this example were given a higher rating by an internal taste panel compared with those from example 3.

### EXAMPLE 8

The brown sugar products obtained according to the present invention are usable in the retail market as table sugar, for home cooking and baking and as addition to breakfast cerial. The brown sugar products are also usable in the industrial market for the preparation of food products. For example the products can be used for baking.

The molasses obtained by the inventive process normally needs to be treated with activated or granular carbon and demineralised by use of ion exchange resins. Such treatment gives a product suitable as a baking syrup or treacle. The syrup can also be blended with cane-based treacle to provide a product with a new taste profile.

The above description of the invention reveals that it is obvious that it can be varied in many ways. Such variations are not to be considered a deviation from the scope of the invention, and all such modifications which are obvious to persons skilled in the art are also to be considered comprised by the scope of the succeeding claims.

1. A process for the preparation of sugar crystals from raw diffuser beet juice by purification followed by evaporative crystallization, characterized in, that the raw juice is subjected to the steps of
a) heating to 70-95° C.,
c) membrane filtration on a filter having a molecular weight cut-off between 2,000 and 500,000 Dalton,
d) evaporation to a dry matter content of between 60 and 80% by weight under vacuum,
e) crystallization by further evaporation followed by phase separation resulting in a crop of sugar crystals and a liquid phase, and
f) one or more further steps wherein the liquid phase from the preceding step is subjected to crystallization by evaporation and phase separation resulting in further crops in the form of sugar crystals and molasses as the liquid phase from the last step.

2. A process for the preparation of sugar crystals from raw diffuser beet juice by purification followed by evaporative crystallization, characterized in, that the raw juice is subjected to the steps of
a) heating to 70-95° C.,
c) membrane filtration on a filter having a molecular weight cut-off between 2,000 and 500,000 Dalton,
d) evaporation to a thick juice having a dry matter content of between 60 and 80% by weight under vacuum,
d1) dividing the thick juice obtained in step d) into a first and a second portion,
e) crystallization by further evaporation of the first portion obtained in step d1) followed by phase separation resulting in a first crop of sugar crystals and a liquid phase, and
f) subjecting the liquid phase obtained in step e) to one or more further steps wherein the liquid phase from the preceding step is subjected to crystallization by evaporation and phase separation resulting in further crops of sugar crystals and molasses as the liquid phase from the last step, and
g) crystallization by further evaporation of the second portion obtained in step d1) followed by phase separation resulting in a crop of sugar crystals and a liquid “green syrup” phase,
h) recycling of the liquid green syrup to be combined with first portion of thick juice obtained in step d1) before this is subjected to the treatment in step e).

3. A process according to claim 2, characterized in, that one or more of the crops of sugar crystals obtained in step e) and/or step f) are combined with the second portion of thick juice obtained in step d1) before this is subjected to the treatment in step g).

4. A process as claimed in claim 1 or claim 2, characterized in, a further step of demineralization by electrodialysis incorporated after the membrane filtration in step c).

5. A process as claimed in claim 4, characterized in, that the membrane filtrated juice obtained in step c) is
preliminary evaporated to a dry matter content of between 25 and 35% by weight under vacuum, and thereafter
demineralized by electrodialysis and then
further evaporated to a thick juice having a dry matter content of between 60 and 80% by weight according to d).

6. A process as claimed in any one of claims 1-3, further comprising a step of
b) pre-filtration
after the heating in step (a) and before the membrane filtration in step (c).

7. A process as claimed in claim 6, wherein the pre-filtration in step (b) is made on a filter having a pore size between 30 and 150 μm.

8. A process as claimed in claim 7, wherein the pre-filtration in step (b) is made on a filter having a pore size between 50 and 100 μm.

9. A process as claimed in claim 1, wherein the thick juice obtained from step (d) is subjected to crystallization in three steps each step including crystallization followed by phase separation.

10. (Cancelled)

11. A process as claimed in claim 2 or 3, whereby the crop of sugar crystals obtained in step (g) is a crop of white sugar.

12. A process according to any one of the preceding claims 1-3 or 9, whereby the sequence of step (d), step (e) and one or more steps (f) is carried out without intermediate cooling.

13. A process according to any one of the preceding claims 1-3 or 9, whereby the process during the sequence including step (d), step (e) and all of the steps (f) is carried out under vacuum.

14. A process according to any one of the preceding claims 1-3 or 9, whereby the membrane filtration in step (c) is carried out on a UP membrane filter having a molecular weight cut-off between 10,000 and 70,000 Dalton.

15. A brown sugar product obtainable from raw diffuser beet juice as one of the crops of sugar crystals by the process according to any one of claims 1-3 or 9.

16. A food product comprising a brown sugar and/or molasses obtainable from raw diffuser beet juice by the process according to any one of claims 1-3 or 9.
